(19) United States
(12) Patent Application Publication
(10) Pub. No.: US 2015/0322261 A1
(43) Pub. Date: Nov. 12, 2015

(54) Reinforced Thermoplastic Resin Composition And Molded Article

(71) Applicant: UMG ABS, LTD., Chuo-ku, Tokyo (JP)

(72) Inventors: Masahito NAKAMOTO, Ube-shi (JP); Hideichiro KAWAGUCHI, Ube-shi, (JP)

(21) Appl. No.: 14/762,237

(22) PCT Filed: Jan. 28, 2014
(86) PCT No.: PCT/JP2014/051815

§ 371 Date: Jul. 21, 2015

(30) Foreign Application Priority Data
Jan. 29, 2013 (JP) 2013-014375

(51) Int. Cl. C08L 69/00

(52) U.S. Cl. CPC C08L 69/00; C08L 2201/02; C08L 2207/04; C08L 2205/03

(57) ABSTRACT

A reinforced thermoplastic resin composition including: a polycarbonate resin (A); a graft copolymer (B) obtained by polymerizing a monomer mixture including an aromatic alkenyl compound monomer (a) and a vinyl cyanide compound monomer (b) in the presence of a rubbery polymer (B1); a glass fiber (D) which is surface-treated with a water-soluble polyurethane and which has a ratio between a major axis and a minor axis in a fiber cross section of at least 2; a glycidyl ether unit-containing polymer (E) which includes a glycidyl ether unit and has a mass average molecular weight of 3,800 to 60,000; a phosphoric acid ester-based flame retardant (F1) having a mass average molecular weight of 300 to 430; a phosphoric acid ester-based flame retardant (F2) having a mass average molecular weight of 550 to 692; and a sulfonic acid metal salt (G), wherein a content ratio of the component (A) is from 93 to 99% by mass and a content ratio of the component (B) is from 1 to 7% by mass with respect to a total mass of 100% by mass of the component (A) and the component (B); a content ratio of the component (D) is from 30 to 50% by mass with respect to a total mass of 100% by mass of the component (A), the component (B), the component (D), the component (E), the component (F1), the component (F2) and the component (G); and with respect to a total of 100 parts by mass of the component (A) and the component (B), a content of the component (E) is from 1 to 10 parts by mass, a content of the component (F1) is from 0.5 to 5 parts by mass, a content of the component (F2) is from 19.5 to 25 parts by mass, a total of the contents of the component (F1) and the component (F2) is from 21 to 29 parts by mass, and a content of the component (G) is from 0.03 to 0.5 parts by mass.

### CROSS-REFERENCE TO RELATED APPLICATION(S)

This application is the U.S. National Phase application of PCT application number PCT/JP2014/051815 having a PCT filing date of Jan. 28, 2014, which claims priority of Japanese Patent Application No. 2013-014375 filed on Jan. 29, 2013, the disclosures of which are hereby incorporated by reference.

### TECHNICAL FIELD

The present invention relates to a thermoplastic resin composition reinforced by glass fibers and a molded article using the same.

### BACKGROUND ART

As materials for the housing of mobile devices (laptop-type and tablet-type personal computers, mobile phones including smartphones, digital cameras, digital video cameras and the like), thermoplastic resin compositions (ABS resins, polycarbonate resin/ABS resins and the like) or materials obtained by reinforcing the aforementioned thermoplastic resin compositions with inorganic fillers have been widely used. As a method for producing a housing, a method of molding the aforementioned thermoplastic resin composition by injection molding with which the shape can be freely molded to some extent has been usually employed.

In recent years, for the housing of mobile devices, further thinning, durability to sufficiently withstand the impact or load when placed in a bag or the like, possible omission of coating for the sake of cost reduction and the like have been required. In order to satisfy these requirements, for the thermoplastic resin compositions used for the housing, not only high rigidity and mechanical strength (such as impact resistance) when formed into a molded article, but also high flame retardancy and favorable moldability during molding have been required.

However, the ABS resins and polycarbonate resins/ABS resins that are not reinforced by the inorganic fillers exhibit low rigidity when formed into a molded article, and thus cannot meet the demands for the thinning of the housing.

In those cases where carbon fibers are used as an inorganic filler, a balance can be achieved between the rigidity and the mass when formed into a molded article. However, since the thermoplastic resin compositions reinforced by carbon fibers exhibit electromagnetic-wave shielding properties, they cannot be used for a wireless LAN type mobile device. In addition, since carbon fibers are black, they cannot meet the demands for a wide range of coloring.

In view of the above, as the thermoplastic resin composition used for the housing, a glass fiber-reinforced thermoplastic resin composition has been studied.

Glass fiber-reinforced thermoplastic resin compositions exhibit high rigidity when formed into a molded article and the housing can be thinned. However, glass fiber-reinforced thermoplastic resin compositions exhibit insufficient flame retardancy and impact resistance when formed into a molded article.

As the reinforced thermoplastic resin compositions capable of obtaining a molded article excellent in impact resistance, the reinforced thermoplastic resin compositions described below have been proposed.

(1) A reinforced thermoplastic resin composition containing an aromatic polycarbonate resin, a fibrous filler which has been surface treated with a polyamide and a lubricant having a carboxyl group (Patent Document 1).

However, the reinforced thermoplastic resin composition (1) has a problem in that the mechanical strength other than the impact resistance is lowered when formed into a molded article.

As the reinforced thermoplastic resin compositions capable of obtaining a molded article with excellent mechanical strength, the reinforced thermoplastic resin compositions described below have been proposed.

(2) A reinforced thermoplastic resin composition containing an aromatic polycarbonate resin, a thermoplastic polyester resin, a glass fiber which has been surface treated with a silane coupling agent and an epoxy resin, and a thermoplastic elastomeric polymer (Patent Document 2).

(3) A reinforced thermoplastic resin composition containing a polycarbonate resin, a rubber-containing polymer and carbon fibers that are bundled with an epoxy-based sizing agent (Patent Document 3).

However, the reinforced thermoplastic resin compositions (2) and (3) exhibit insufficient impact resistance when formed into a molded article.

It should be noted that as a reinforced thermoplastic resin composition exhibiting high moldability, providing mechanical strength and high plating properties for the resulting molded article and capable of improving the surface appearance of the molded article after plating, the reinforced thermoplastic resin compositions described below have been proposed.

(4) A reinforced thermoplastic resin composition containing a graft copolymer in which a graft chain containing an aromatic alkenyl compound monomer unit and a vinyl cyanide compound monomer unit is grafted with a rubbery polymer, a matrix polymer (polycarbonate resin or the like), an inorganic filler of 0.1 to 60 parts by mass with respect to a total of 100 parts by mass of the graft copolymer and the matrix polymer, a glycidyl ether unit-containing polymer and a phosphoric acid ester-based flame retardant (Patent Document 4).

However, the reinforced thermoplastic resin composition (4) cannot deal with the demands for the thinning of the housing since the rigidity is low when formed into a molded article if the amount of inorganic filler added is 60 parts by mass or less. On the other hand, if the added amount of inorganic filler is more than 60 parts by mass, the moldability would be insufficient.

In addition to the reinforced thermoplastic resin compositions (1) to (4), for the sake of improving the flame retardancy and mechanical strength of the molded article, a multitude of reinforced thermoplastic resin compositions obtained by adding an epoxy compound have been proposed. However, a reinforced thermoplastic resin composition excellent in balance between the moldability and the flame retardancy, mechanical strength and impact resistance of the obtained molded article has not been proposed yet.

### CITATION LIST

### Patent Documents

[Patent Document 1] Japanese Unexamined Patent Application, First Publication No. 2001-240738

[Patent Document 2] Japanese Unexamined Patent Application, First Publication No. Hei 06-49344

[Patent Document 3] Japanese Unexamined Patent Application, First Publication No. Sho 60-88062

[Patent Document 4] Japanese Unexamined Patent Application, First Publication No. 2009-155577

### SUMMARY OF THE INVENTION

### Technical Problem

The present invention has an object of providing a reinforced thermoplastic resin composition exhibiting favorable moldability and capable of enhancing the flame retardancy, rigidity, impact resistance, mechanical strength and heat resistance of the resulting molded article, as well as a molded article exhibiting high flame retardancy, rigidity, impact resistance, mechanical strength and heat resistance.

### Solution to Problem

The present invention includes the following aspects.

[1] A reinforced thermoplastic resin composition including: a polycarbonate resin (A);

a graft copolymer (B) obtained by polymerizing a monomer mixture containing an aromatic alkenyl compound monomer (a) and a vinyl cyanide compound monomer (b) in the presence of a rubbery polymer (B1);

a glass fiber (D) surface-treated with a water-soluble polyurethane and having a ratio between a major axis and a minor axis ((major axis)/(minor axis)) in a fiber cross section of at least 2 and not more than 6;

a glycidyl ether unit-containing polymer (E) which includes a glycidyl ether unit and has a mass average molecular weight of 3,800 to 60,000 (with a proviso that the aforementioned graft copolymer (B) is excluded);

a phosphoric acid ester-based flame retardant (F1) having a mass average molecular weight of 300 to 430;

a phosphoric acid ester-based flame retardant (F2) having a mass average molecular weight of 550 to 692; and

a sulfonic acid metal salt (G), wherein

a content ratio of the aforementioned polycarbonate resin (A) is from 93 to 99% by mass with respect to a total mass of 100% by mass of the aforementioned polycarbonate resin (A) and the aforementioned graft copolymer (B), with a proviso that the total mass of the aforementioned polycarbonate resin (A) and the aforementioned graft copolymer (B) does not exceed 100% by mass;

a content ratio of the aforementioned graft copolymer (B) is from 1 to 7% by mass with respect to a total mass of 100% by mass of the aforementioned polycarbonate resin (A) and the aforementioned graft copolymer (B);

a content ratio of the aforementioned glass fiber (D) is from 30 to 50% by mass with respect to a total mass of 100% by mass of the aforementioned polycarbonate resin (A), the aforementioned graft copolymer (B), the aforementioned glass fiber (D), the aforementioned glycidyl ether unit-containing polymer (E), the aforementioned phosphoric acid ester-based flame retardant (F1), the aforementioned phosphoric acid ester-based flame retardant (F2) and the aforementioned sulfonic acid metal salt (G);

a content of the aforementioned glycidyl ether unit-containing polymer (E) is from 1 to 10 parts by mass with respect to a total of 100 parts by mass of the aforementioned polycarbonate resin (A) and the aforementioned graft copolymer (B);

a content of the aforementioned phosphoric acid ester-based flame retardant (F1) is from 0.5 to 5 parts by mass with respect to a total of 100 parts by mass of the aforementioned polycarbonate resin (A) and the aforementioned graft copolymer (B);

a content of the aforementioned phosphoric acid ester-based flame retardant (F2) is from 19.5 to 25 parts by mass with respect to a total of 100 parts by mass of the aforementioned polycarbonate resin (A) and the aforementioned graft copolymer (B);

a total of the content of the aforementioned phosphoric acid ester-based flame retardant (F1) and the content of the aforementioned phosphoric acid ester-based flame retardant (F2) is from 21 to 29 parts by mass with respect to a total of 100 parts by mass of the aforementioned polycarbonate resin (A) and the aforementioned graft copolymer (B); and

a content of the aforementioned sulfonic acid metal salt (G) is from 0.03 to 0.5 parts by mass with respect to a total of 100 parts by mass of the aforementioned polycarbonate resin (A) and the aforementioned graft copolymer (B).

[2] A molded article which is formed through molding and processing of the reinforced thermoplastic resin composition according to the aspect [1].

### Advantageous Effects of Invention

The reinforced thermoplastic resin composition of the present invention exhibits favorable moldability and is capable of enhancing the flame retardancy, rigidity, impact resistance, mechanical strength and heat resistance of the resulting molded article.

The molded article of the present invention exhibits high flame retardancy, rigidity, impact resistance, mechanical strength and heat resistance.

### DESCRIPTION OF EMBODIMENTS

[Reinforced Thermoplastic Resin Composition]

A reinforced thermoplastic resin composition of the present invention contains a polycarbonate resin (A), a graft copolymer (B), a glass fiber (D), a glycidyl ether unit-containing polymer (E), a phosphoric acid ester-based flame retardant (F1), a phosphoric acid ester-based flame retardant (F2) and a sulfonic acid metal salt (G) as essential components.

Hereinafter, a component composed of the polycarbonate resin (A) and the graft copolymer (B) will also be referred to as a main resin component (C). In addition, a component composed of a phosphoric acid ester-based flame retardant (F1) and a phosphoric acid ester-based flame retardant (F2) will also be described as a phosphoric acid ester-based flame retardant (F).

<Polycarbonate Resin (A)>

A polycarbonate resin (A) is a resin obtained from a dihydroxydiarylalkane. The polycarbonate resin (A) may be optionally branched. For the polycarbonate resin (A), one type of resin may be used alone, or two or more types of resins may be used in combination.

As the dihydroxydiarylalkane, for example, a dihydroxydiarylalkane having an alkyl group at the ortho position relative to the hydroxy group is preferred.

[Method of Producing Polycarbonate Resin (A)]

The polycarbonate resin (A) is produced by a known method. For example, this can be produced through a method of reacting a dihydroxy or polyhydroxy compound with phosgene or a carbonate diester, or through a melt polymerization method.

A polycarbonate resin (A) having a branched structure is produced, for example, by replacing part of a dihydroxy compound (for example, 0.2 to 2 mol %) with a polyhydroxy compound (substitution reaction). Specific examples of the polyhydroxy compound include phloroglucinol, 4,6-dimethyl-2,4,6-tri-(4-hydroxyphenyl)-heptene, 4,6-dimethyl-2,4,6-tri-(4-hydroxyphenyl)-heptane and 1,3,5-tri-(4-hydroxyphenyl)-benzene.

As the polycarbonate resin (A), a polycarbonate resin recycled from a compact disc or the like may be used.

### [Viscosity Average Molecular Weight of Polycarbonate Resin (A)]

The viscosity average molecular weight (Mv) of the polycarbonate resin (A) is preferably from 15,000 to 35,000. If the viscosity average molecular weight of the polycarbonate resin (A) is equal to or more than 15,000, the impact resistance of the molded article is further increased. If the viscosity average molecular weight of the polycarbonate resin (A) is equal to or less than 35,000, the moldability of the reinforced thermoplastic resin composition is further increased. The viscosity average molecular weight (Mv) of the polycarbonate resin (A) is more preferably from 17,000 to 25,000 from the viewpoint that a balance between the mechanical strength and impact resistance of the molded article and the fluidity of the reinforced thermoplastic resin composition is particularly excellent.

The phrase “viscosity average molecular weight (Mv) of the polycarbonate resin (A)” refers to a value obtained by inserting a specific viscosity [ηsp] determined from a solution obtained by dissolving 0.7 g of the polycarbonate resin in 100 ml of methylene chloride at 20° C. to the following equation (where [η] represents the limiting viscosity).

[ηsp]/c=[η]+0.45×[η] 2c

[η]=1.23×10−4×Mv0.83

c=0.7 (concentration of the solution obtained by dissolving 0.7 g of the polycarbonate resin in 100 ml of methylene chloride at 20° C.)

In addition, in the case of using a commercially available polycarbonate resin (A), catalog values may be used.

### [Content Ratio of Polycarbonate Resin (A)]

A content ratio of the polycarbonate resin (A) is from 93 to 99% by mass and is preferably from 94 to 98% by mass with respect to a total mass of 100% by mass of the main resin component (C). If the content ratio of the polycarbonate resin (A) is equal to or more than 93% by mass, the impact resistance of the molded article becomes high. If the content ratio of the polycarbonate resin (A) is equal to or less than 99% by mass, the moldability of the reinforced thermoplastic resin composition becomes favorable.

<Graft Copolymer (B)>

The graft copolymer (B) is a graft polymer obtained by polymerizing a monomer mixture containing an aromatic alkenyl compound monomer (a) and a vinyl cyanide compound monomer (b) in the presence of a rubbery polymer (B1), and is a polymer in which a molecular chain (B2) having an aromatic alkenyl compound monomer (a) unit and a vinyl cyanide compound monomer (b) unit is grafted to the rubbery polymer (B1).

As the graft copolymer (B), a single type of component may be used alone, or two or more types of components may be used in combination.

[Rubbery Polymer (B1)]

Examples of the rubbery polymer (B1) include a butadiene rubber, a styrene-butadiene rubber, an acrylonitrile-butadiene rubber, an isoprene rubber, a chloroprene rubber, a butyl rubber, an ethylene-propylene rubber, an acrylic rubber, an ethylene-propylene-nonconjugated diene rubber, an epichrolohydrin rubber, a diene-acrylic composite rubber and a silicone (polysiloxane)-acrylic composite rubber. Among these, from the viewpoint of favorable plating performance of the resulting molded article, a butadiene rubber, a styrene-butadiene rubber, an acrylonitrile-butadiene rubber, an acrylic rubber, a diene-acrylic composite rubber and a silicone-acrylic composite rubber are preferred, and from the viewpoint of favorable flame retardancy of the resulting molded article, a silicone-acrylic composite rubber is more preferred.

Here, a diene component in the above diene-acrylic composite rubber contains at least 50% by mass and not more than 90% by mass of butadiene units with respect to a total mass of the diene-acrylic composite rubber. Examples of the diene component include a butadiene rubber, a styrene-butadiene rubber and an acrylonitrile-butadiene rubber.

The acrylic rubber component in the diene-acrylic composite rubber is a component obtained by polymerization between an alkyl (meth)acrylate (f) and a polyfunctional monomer (g).

Examples of the alkyl (meth)acrylate (f) include alkyl acrylates having an alkyl group of 1 to 8 carbon atoms (more specifically, methyl acrylate, ethyl acrylate, n-propyl acrylate, n-butyl acrylate, 2-ethylhexyl acrylate and the like) and alkyl methacrylates having an alkyl group of 6 to 12 carbon atoms (more specifically, hexyl methacrylate, 2-ethylhexyl methacrylate, n-lauryl methacrylate and the like). As the alkyl (meth)acrylate (f), a single type of component may be used alone, or two or more types of components may be used in combination.

Examples of the polyfunctional monomer (g) include allyl methacrylate, ethylene glycol dimethacrylate, propylene glycol dimethacrylate, 1,3-butylene glycol dimethacrylate, 1,4-butylene glycol dimethacrylate, triallyl cyanurate and triallyl isocyanurate. As the polyfunctional monomer (g), a single type of monomer may be used alone, or two or more types of monomers may be used in combination.

Examples of the composite structure of the diene-acrylic composite rubber described above include a core shell structure in which the periphery of a diene component is covered with an acrylic rubber component; a core shell structure in which the periphery of an acrylic rubber component is covered with a diene component; a structure in which a diene component and an acrylic rubber component are intertwined with each other, and a copolymer structure in which diene-based monomer units and alkyl (meth)acrylate-based monomer units are randomly arranged.

Among them, as the composite structure of the diene-acrylic composite rubber, the core shell structure in which the periphery of a diene component is covered with an acrylic rubber component and the structure in which a diene component and an acrylic rubber component are intertwined with each other are preferred.

The silicone component of the silicone-acrylic composite rubber described above is a silicone component composed mainly of a polyorganosiloxane. As the silicone component, a polyorganosiloxane containing a vinyl polymerizable functional group is preferred.

Examples of the acrylic rubber component of the silicone-acrylic composite rubber include the same component as the acrylic rubber component of the diene-acrylic composite rubber.

As the composite structure of the silicone-acrylic composite rubber, a core shell structure in which the periphery of a silicone component is covered with an acrylic rubber component; a core shell structure in which the periphery of an acrylic rubber component is covered with a silicone component; a structure in which a silicone component and an acrylic rubber component are intertwined with each other; a structure in which polyorganosiloxane segments and polyalkyl(meth)acrylate segments are linearly and sterically bound to each other to form a network-like rubber structure and the like can be mentioned.

Among them, as the composite structure of the silicone-acrylic composite rubber, a structure in which a silicone component and an acrylic rubber component are intertwined with each other is preferred.

The rubbery polymer (B1) is prepared, for example, by the emulsion polymerization of a monomer that forms the rubbery polymer (B1) in the presence of a radical polymerization initiator. According to the preparation method by emulsion polymerization, the particle size of the rubbery polymer (B1) can be readily controlled.

The average particle size of the rubbery polymer (B1) is preferably from 0.1 to 0.6 μm from the viewpoint that the impact resistance of the molded article can be further increased.

It should be noted that the term “average particle size” used herein refers to a mass average particle size and can be determined by a known measuring method.

The content of the rubbery polymer (B1) is preferably from 0.5 to 3.5% by mass, with respect to a total mass of 100% by mass of the main resin component (C). If the content of the rubbery polymer (B1) is equal to or more than 0.5% by mass, it is possible to further increase the impact resistance of the molded article. If the content of the rubbery polymer (B1) is equal to or less than 3.5% by mass, the moldability of the reinforced thermoplastic resin composition would be further improved, and the outer appearance of the molded article would be improved.

[Molecular Chain (B2)]

A molecular chain (B2) includes an aromatic alkenyl compound monomer unit (a) and a vinyl cyanide compound monomer unit (b) as essential components and another monomer unit (c) copolymerizable with these units as an optional component.

For the proportion of each monomer unit, from the viewpoint of excellent balance between the impact resistance of the molded article and the moldability of the reinforced thermoplastic resin composition, with respect to a total mass of 100% by mass of the monomers (a) to (c), the content ratio of the aromatic alkenyl compound monomer (a) unit is preferably from 50 to 90% by mass, the content ratio of the vinyl cyanide compound monomer (b) unit is preferably from 10 to 50% by mass and the content ratio of the another monomer (c) unit is preferably from 0 to 40% by mass.

Examples of the aromatic alkenyl compound monomer unit (a) include styrene, α-methylstyrene and vinyltoluene, and styrene is preferred.

Examples of the vinyl cyanide compound monomer unit (b) include acrylonitrile and methacrylonitrile, and acrylonitrile is preferred.

Examples of the another monomer unit (c) include alkyl methacrylates with an alkyl group of 1 to 8 carbon atoms (such as methyl methacrylate, ethyl methacrylate and 2-ethylhexyl methacrylate), alkyl acrylates with an alkyl group of 1 to 4 carbon atoms (such as methyl acrylate, ethyl acrylate and butyl acrylate) and maleimide compounds (such as N-phenylmaleimide).

[Acetone-Insoluble Fraction and Acetone-Soluble Fraction of Graft Copolymer (B)]

The graft copolymer (B) includes an acetone-soluble fraction and an acetone-insoluble fraction.

It should be noted that the term “acetone-soluble fraction” used herein refers to a polymer which is similar to the molecular chain (B2) but not grafted to the rubbery polymer (B1). The acetone-soluble fraction is often generated at the same time when the molecular chain (B2) is being grafted to the rubbery polymer (B1). Therefore, the graft copolymer (B) includes the acetone-soluble fraction and the acetone-insoluble fraction.

It is preferable that the graft copolymer (B) contain 70 to 99% by mass of the acetone-insoluble fraction within the total mass of 100% by mass of the graft copolymer (B), and also that the reduced viscosity of the acetone-soluble fraction when measuring a measurement solution prepared with a N,N-dimethylformamide solution at 25° C. so that the concentration of the acetone-soluble fraction is 0.2 g/dl is from 0.3 to 0.7 dl/g.

If the acetone-insoluble fraction in the graft copolymer (B) accounts for at least 70% by mass, the surface appearance of the molded article becomes favorable and the moldability of the reinforced thermoplastic resin composition is further improved. If the fraction insoluble in an acetone solvent in the graft copolymer (B) (acetone-insoluble fraction in the graft copolymer (B)) accounts for 99% by mass or less, the tear strength of the molded article is improved.

If the aforementioned reduced viscosity of the acetone-soluble fraction is 0.3 dl/g or higher, the tear strength of the molded article is improved. If the aforementioned reduced viscosity of the acetone-soluble fraction is 0.7 dl/g or lower, the surface appearance of the molded article becomes favorable and the moldability of the reinforced thermoplastic resin composition is further improved.

The method of measuring the acetone-soluble fraction is as follows.

2.5 g of the graft copolymer is immersed in 90 ml of acetone, heated at 65° C. for 3 hours, and then centrifuged at 1,500 rpm for 30 minutes by using a centrifugal separator. Thereafter, the supernatant liquid is discarded and the residue is dried at 65° C. for 12 hours in a vacuum drier, and the resulting sample after drying is precisely weighed. From the mass difference (namely, (2.5 g)−(mass of the sample after drying)), the ratio (%) of the acetone-soluble fraction in the graft copolymer can be determined. The reduced viscosity of the acetone-soluble fraction is measured at 25° C. by preparing an N,N-dimethylformamide solution in which the acetone-soluble fraction is 0.2 g/dl.

[Production Method of Graft Copolymer (B)]

The graft copolymer (B) can be obtained by graft-polymerizing the aromatic alkenyl compound monomer (a) and the vinyl cyanide compound monomer (b), and, if necessary, the another monomer (c), in the presence of the rubbery polymer (B1).

As a graft polymerization method, an emulsion polymerization method is preferred. In addition, at the time of graft polymerization, various chain transfer agents may be added in order to adjust the molecular weight and graft rate of the graft copolymer (B) and the reduced viscosity of the acetone-soluble fraction.

[Content Ratio of Graft Copolymer (B)]

A content ratio of the graft copolymer (B) is from 1 to 7% by mass and is preferably from 2 to 6% by mass with respect to a total mass of 100% by mass of the main resin component (C). If the content ratio of the graft copolymer (B) is equal to or more than 1% by mass, the moldability of the reinforced thermoplastic resin composition becomes favorable. If the content ratio of the graft copolymer (B) is equal to or less than 7% by mass, the impact resistance of the molded article becomes high.

<Glass Fiber (D)>

A glass fiber (D) is a glass fiber surface-treated with a water-soluble polyurethane and having a ratio between a major axis and a minor axis ((major axis)/(minor axis)) in a fiber cross section of at least 2 and not more than 6. As the glass fiber (D), a single type of component may be used alone, or two or more types of components may be used in combination.

It should be noted that the term “surface treatment” used in the specification and the claims of the present application refers to a surface treatment using a sizing agent, a chemical treatment in order to control the compatibility and affinity with a resin or the like.

[Water-Soluble Polyurethane]

The “water-soluble polyurethane” is a polyurethane which can be dissolved or dispersed in water. Examples of the water-soluble polyurethane include the water-soluble polyurethanes known as the surface treating agents (sizing agents) for glass fibers.

[Ratio Between Major Axis and Minor Axis]

A ratio between the major axis and the minor axis ((major axis)/(minor axis)) in a fiber cross section of the glass fiber (D) is at least 2, preferably 2 to 6 and more preferably 2 to 4. If the (major axis)/(minor axis) ratio is 2 or more, the moldability of the reinforced thermoplastic resin composition becomes favorable, and the mechanical strength of the molded article becomes high. If the (major axis)/(minor axis) ratio is 6 or less, the shaping properties (extrusion workability) of the reinforced thermoplastic resin composition is improved.

It should be noted that the expression “fiber cross section” used herein refers to a cross section perpendicular with respect to the fiber length direction and the (major axis)/(minor axis) in the fiber cross section refers to the major axis and the minor axis, respectively, of the cross sections having a square or elliptical shape or the like. The major axis/minor axis in the fiber cross section of the glass fiber (D) can be obtained, for example, by observing the fiber cross section of the glass fiber (D) at 20 arbitrary locations using an electron microscope and averaging the major axes/minor axes of 20 arbitrary locations. In addition, in the case of using a commercially available glass fiber (D), catalog values may be used.

[Production Method of Glass Fiber (D)]

The glass fiber (D) can be obtained by treating the surface of an untreated glass fiber with a coupling agent (for example, a silane-based coupling agent or a titanate-based coupling agent) or the like, and subjecting the resultant to a further surface treatment with a water-soluble polyurethane.

The untreated glass fiber may be either a long fiber or a short fiber. As the untreated glass fiber, a short fiber with low anisotropy is preferred, and a chopped fiber is more preferred.

[Content Ratio of Glass Fiber (D)]

A content ratio of the glass fiber (D) is from 30 to 50% by mass and is preferably from 35 to 45% by mass with respect to a total content of 100% by mass of the main resin component (C), the glass fiber (D), the glycidyl ether unit-containing polymer (E) to be described later, the phosphoric acid ester-based flame retardant (F) to be described later and the sulfonic acid metal salt (G) to be described later. If the ratio of the glass fiber (D) is equal to or more than 30% by mass, the rigidity of the molded article and the like become high. If the ratio of the glass fiber (D) is equal to or less than 50% by mass, the moldability of the reinforced thermoplastic resin composition becomes favorable.

<Glycidyl Ether Unit-Containing Polymer (E)>

The glycidyl ether unit-containing polymer (E) is a polymer having a glycidyl ether unit in the molecule. A polymer having a halogen atom (bromine or the like) or a block polymer is not included in the glycidyl ether unit-containing polymer (E).

Examples of the glycidyl ether unit-containing polymer (E) include glycidyl ether-type epoxy resins yielded by a reaction between a compound having a hydroxy group and epichlorohydrin.

Examples of the glycidyl ether-type epoxy resins include high molecular weight substances, such as bisphenol type epoxy resins, novolac type epoxy resins, polyglycidyl ethers of aliphatic polyhydric alcohols and biphenyl type epoxy resins, which have a molecular chain with repeating units represented by the following formula (1) (for example, an epoxy group-containing phenoxy resin).

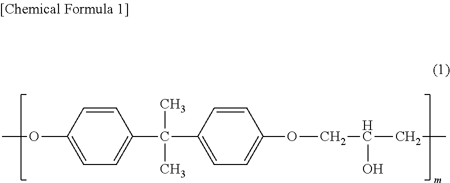

Note that the symbol m represents an integer of 1 or greater.

Examples of the bisphenol type epoxy resins include a bisphenol A type epoxy resin, a bisphenol F type epoxy resin, a bisphenol AD type epoxy resin, and an epoxy resin having structures of both bisphenol A and bisphenol F. Examples of the novolac type epoxy resins include a phenol novolac type epoxy resin and a cresol novolac type epoxy resin.

Examples of the polyglycidyl ethers of aliphatic polyhydric alcohols include alkylene glycol diglycidyl ethers (such as ethylene glycol diglycidyl ether), polyoxyalkylene glycol diglycidyl ethers (such as diethylene glycol diglycidyl ether, polyethylene glycol diglycidyl ether, dipropylene glycol diglycidyl ether, tripropylene glycol diglycidyl ether and polypropylene glycol diglycidyl ether) and glycerol triglycidyl ether.

As the glycidyl ether unit-containing polymer (E), from the viewpoint of further increasing the mechanical strength of the molded article, a bisphenol A type epoxy resin, a bisphenol F type epoxy resin, an epoxy resin having structures of both bisphenol A and bisphenol F, a phenol novolac type epoxy resin, a cresol novolac type epoxy resin and an epoxy group-containing phenoxy resin are preferred.

The glycidyl ether unit-containing polymer (E) may be in a liquid state, a semi-solid state or a solid state at normal temperature (20° C.). In view of the workability during mixing and kneading and the like, a solid polymer is preferred.

As the glycidyl ether type epoxy resin, a single type of component may be used alone, or two or more types of components may be used in combination.

[Mass Average Molecular Weight of Glycidyl Ether Unit-Containing Polymer (E)]

The mass average molecular weight of the glycidyl ether unit-containing polymer (E) is from 3,800 to 60,000, and preferably from 5,500 to 50,000. If the mass average molecular weight of the glycidyl ether unit-containing polymer (E) is 3,800 or more, the impact resistance and mechanical strength of the molded article become high. If the mass average molecular weight of the glycidyl ether unit-containing polymer (E) is 60,000 or less, the flame retardancy of the molded article becomes high and the moldability of the reinforced thermoplastic resin composition becomes favorable.

The mass average molecular weight of the glycidyl ether unit-containing polymer (E) can be determined by a known mass spectrometry technique. In addition, in the case of using a commercially available glycidyl ether unit-containing polymer (E), catalog values may be used.

[Method for Obtaining Glycidyl Ether Unit-Containing Polymer (E)]

The glycidyl ether unit-containing polymer (E) can be produced by a known method.

Examples of commercially available products of the glycidyl ether unit-containing polymer (E) include jER (registered trademark) series manufactured by Mitsubishi Chemical Corporation, Epotohto (registered trademark) series and Phenotohto (registered trademark) series manufactured by Nippon Steel & Sumikin Chemical Co., Ltd., AER (registered trademark) series manufactured by Asahi Kasei E-materials Corporation and Epiclon (registered trademark) series manufactured by DIC Corporation.

[Content of Glycidyl Ether Unit-Containing Polymer (E)]

The content of the glycidyl ether unit-containing polymer (E) is from 1 to 10 parts by mass and preferably from 3 to 8 parts by mass with respect to 100 parts by mass of the main resin component (C). When the content of the glycidyl ether unit-containing polymer (E) is 1 part by mass or more, the mechanical strength and impact resistance of the molded article become high. If the content of the glycidyl ether unit-containing polymer (E) is 10 parts by mass or less, the moldability of the reinforced thermoplastic resin composition becomes favorable and the flame retardancy of the molded article becomes high.

<Phosphoric Acid Ester-Based Flame Retardant (F)>

The phosphoric acid ester-based flame retardant is a compound represented by the following formula (2), and is composed of a phosphoric acid ester-based flame retardant (F1) having a mass average molecular weight of 300 to 430 and a phosphoric acid ester-based flame retardant (F2) having a mass average molecular weight of 550 to 690.

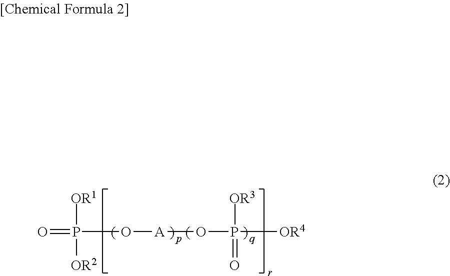

In the formula (2), each of R1, R2, R3 and R4 independently represents a hydrogen atom or an organic group, provided that not all the R1, R2, R3 and R4 are hydrogen atoms at the same time; A represents a divalent or higher organic group, p represents 0 or 1, q represents an integer of 1 or more, and r represents an integer of 0 or more.

Examples of the “organic groups represented by R1, R2, R3 and R4” include an alkyl group which may be substituted (such as a methyl group, an ethyl group, a butyl group and an octyl group), a cycloalkyl group (such as a cyclohexyl group), and an aryl group (such as a phenyl group and an alkyl group-substituted phenyl group).

The number of substituents, if any, is not limited.

Examples of the substituents for the substituted organic group include an alkoxy group, an alkylthio group, an aryloxy group and an arylthio group. In addition, the substituent for the substituted organic group may be a group in which these substituents are combined (such as an arylalkoxylalkyl group) or a group in which these substituents are combined by bonding through an oxygen atom, a nitrogen atom, a sulfur atom or the like (such as an arylsulfonyl aryl group).

The term “divalent or higher organic group” refers to a divalent or higher functional group obtained by further removing one or more hydrogen atoms bonded to carbon atom(s) from the aforementioned organic group.

Examples thereof include an alkylene group and a (substituted) phenylene group. The position of hydrogen atoms removed from the carbon atom(s) is arbitrary.

Specific examples of the phosphoric acid ester-based flame retardant (F) include trimethyl phosphate, triethyl phosphate, tributyl phosphate, trioctyl phosphate, tributoxyethyl phosphate, triphenyl phosphate, tricresyl phosphate, trixyl phosphate, cresyl diphenyl phosphate, xyl diphenyl phosphate, octyl diphenyl phosphate, diphenyl-2-ethylcresyl phosphate, tris(isopropylphenyl)phosphate, resorcinyl diphenyl phosphate and polyphosphates (such as bisphenol A bisphosphate, hydroquinone bisphosphate, resorcinol bisphosphate, trioxybenzene triphosphate, bisphenol A bis(dicresyl phosphate), phenylenebis(diphenyl phosphate), phenylenebis(ditolyl phosphate) and phenylenebis(dixylyl phosphate)).

Polyphosphates that are one of the specific examples of the phosphoric acid ester-based flame retardant (F) described above can be obtained by, for example, dehydration and condensation between various diol forms such as polynuclear phenols (for example, bisphenol A and the like) and an orthophosphoric acid. Examples of the diol forms include hydroquinone, resorcinol, diphenylolmethane, diphenyloldimethylmethane, dihydroxybiphenyl, p,p′-dihydroxy diphenyl sulfone and dihydroxynaphthalene.

As the phosphoric acid ester-based flame retardant (F1), a single type of component may be used alone, or two or more types of components may be used in combination. As the phosphoric acid ester-based flame retardant (F2), a single type of component may be used alone, or two or more types of components may be used in combination.

[Mass Average Molecular Weight of Phosphoric Acid Ester-Based Flame Retardant (F)]

The mass average molecular weight of the phosphoric acid ester-based flame retardant (F1) is from 300 to 430 and preferably from 326 to 410. If the mass average molecular weight of the phosphoric acid ester-based flame retardant (F1) is from 300 to 430, the flame retardancy of the molded article becomes high.

The mass average molecular weight of the phosphoric acid ester-based flame retardant (F2) is from 550 to 692 and preferably from 574 to 686. If the mass average molecular weight of the phosphoric acid ester-based flame retardant (F2) is from 550 to 692, the flame retardancy of the molded article becomes high.

The mass average molecular weight of the phosphoric acid ester-based flame retardant (F) can be determined by a known mass spectrometry technique. In the case of using a commercially available phosphoric acid ester-based flame retardant (F), catalog values may be used.

[Method for Obtaining Phosphoric Acid Ester-Based Flame Retardant (F)]

The phosphoric acid ester-based flame retardant (F) can be produced by a known method.

Examples of commercially available products of the phosphoric acid ester-based flame retardant (F) include FP series manufactured by ADEKA Corporation, Kronitex (registered trademark) series manufactured by Ajinomoto Fine-Techno Co., Inc., REOFOS (registered trademark) series manufactured by Chemtura Japan Ltd., and CR series and PX series manufactured by Daihachi Chemical Industry Co., Ltd.

[Content of Phosphoric Acid Ester-Based Flame Retardant (F)]

The content of the phosphoric acid ester-based flame retardant (F) (that is, the total content of the phosphoric acid ester-based flame retardant (F1) and the phosphoric acid ester-based flame retardant (F2)) is from 21 to 29 parts by mass and preferably from 22 to 25 parts by mass with respect to 100 parts by mass of the main resin component (C). If the content of the phosphoric acid ester-based flame retardant (F) is equal to or more than 21 parts by mass, the flame retardancy of the molded article becomes high. If the content of the phosphoric acid ester-based flame retardant (F) is equal to or less than 29 parts by mass, the heat resistance and impact resistance of the molded article become high.

The content of the phosphoric acid ester-based flame retardant (F1) is from 0.5 to 5 parts by mass and preferably from 1 to 3 parts by mass with respect to 100 parts by mass of the main resin component (C). If the content of the phosphoric acid ester-based flame retardant (F1) is from 0.5 to 5 parts by mass, the flame retardancy of the molded article becomes high.

The content of the phosphoric acid ester-based flame retardant (F2) is from 19.5 to 25 parts by mass and preferably from 20 to 23 parts by mass with respect to 100 parts by mass of the main resin component (C). If the content of the phosphoric acid ester-based flame retardant (F2) is from 19.5 to 25 parts by mass, the flame retardancy of the molded article becomes high.

<Sulfonic Acid Metal Salt (G)>

Examples of the sulfonic acid metal salt (G) include alkali (earth) metal salts of aliphatic sulfonic acids, monomeric or polymeric alkali (earth) metal salts of aromatic sulfonic acids and alkali (earth) metal salts of sulfuric acid esters. The expression “alkali (earth) metal salt” refers to an alkali metal salt or an alkaline earth metal salt.

Preferred examples of the alkali (earth) metal salts of aliphatic sulfonic acids include alkali (earth) metal salts of alkanesulfonic acids, alkali (earth) metal salts obtained by substituting a portion of alkyl groups of the alkali (earth) metal salts of alkane sulfonic acids with fluorine atoms and alkali (earth) metal salts of perfluoroalkanesulfonic acids. As the alkali (earth) metal salt of an alkanesulfonic acid, a sodium salt of ethanesulfonic acid is preferred. As the alkali (earth) metal salt of a perfluoroalkanesulfonic acid, a potassium salt of perfluorobutanesulfonic acid is preferred.

Examples of the monomeric or polymeric alkali (earth) metal salts of aromatic sulfonic acids include the alkali (earth) metal salts described in Japanese Unexamined Patent Application, First Publication No. Sho 52-54746, and, for example, sodium diphenylsulfone-3-sulfonate, potassium diphenylsulfone-3-sulfonate, dipotassium diphenylsulfone-3,3′-disulfonate, dipotassium diphenylsulfone-3,4′-disulfonate and the like can be mentioned.

Examples of the alkali (earth) metal salts of sulfuric acid esters include alkali (earth) metal salts of sulfuric acid esters having at least one alcohol selected from the group consisting particularly of monohydric and polyhydric alcohols. Examples of the sulfuric acid esters having at least one alcohol selected from the group consisting of monohydric and polyhydric alcohols include methyl sulfate, ethyl sulfate, lauryl sulfate, hexadecyl sulfate, sulfuric acid esters of polyoxyethylene alkyl phenyl ether, mono-, di-, tri- or tetra-sulfuric acid ester of pentaerythritol, sulfuric acid ester of monoglyceride laurate, sulfuric acid ester of monoglyceride palmitate and sulfuric acid ester of monoglyceride stearate. As the alkali (earth) metal salt of sulfuric acid ester, alkali (earth) metal salts of lauryl sulfate are preferred.

As the sulfonic acid metal salt (G), alkali (earth) metal salts of aromatic sulfonic acids and alkali (earth) metal salts of perfluoroalkanesulfonic acids are preferred, and alkali (earth) metal salts of perfluoroalkanesulfonic acids are more preferred. As the sulfonic acid metal salt (G), a single type of component may be used alone, or two or more types of components may be used in combination.

[Content of Sulfonic Acid Metal Salt (G)]

The content of the sulfonic acid metal salt (G) is from 0.03 to 0.5 parts by mass and preferably from 0.05 to 0.2 parts by mass with respect to 100 parts by mass of the main resin component (C). If the content of the sulfonic acid metal salt (G) is equal to or more than 0.03 parts by mass, the flame retardancy of the molded article becomes high. If the content of the sulfonic acid metal salt (G) is equal to or less than 0.5 parts by mass, a decrease in the flame retardancy of the molded article can be suppressed. In addition, if the content of the sulfonic acid metal salt (G) is within the aforementioned range, it is possible to reduce the decrease in the heat resistance which is reduced by the addition of the phosphoric acid ester-based flame retardant (F).

The sulfonic acid metal salt (G) can be produced by a known method.

In addition, examples of the commercially available products of the phosphoric acid ester-based flame retardant (F) include Chemguard manufactured by Sun Chemical Company Ltd.

<Other Flame Retardants>

In addition to the phosphoric acid ester-based flame retardant (F), a known non-halogenated flame retardant may be added to the reinforced thermoplastic resin composition of the present invention so as to be used in combination with the phosphoric acid ester-based flame retardant (F). Examples of the non-halogenated flame retardants include inorganic flame retardants such as phosphazene, phosphorus-containing polyesters, red phosphorus and aluminum hydroxide.

As the red phosphorus-based flame retardant, a red phosphorus-based flame retardant stabilized by being coated with a thermosetting resin or a red phosphorus-based flame retardant stabilized by being coated with a thermosetting resin and a metal hydroxide is used. Since the red phosphorus-based flame retardant is flammable on its own, it may be mixed with at least a portion of the main resin component (C) or the polycarbonate resin (A) in advance to form a master batch.

<Flame Retardant Auxiliary Agent (I)>

A flame retardant auxiliary agent (I) in order to prevent the dripping during combustion may be added to the reinforced thermoplastic resin composition of the present invention. Examples of the flame retardant auxiliary agents include polytetrafluoroethylene, compounds having a tetrafluoroethylene unit, and silicone-based polymers.

In the case of blending polytetrafluoroethylene or a compound having a tetrafluoroethylene unit as the flame retardant auxiliary agent (I), the content of the flame retardant auxiliary agent (I) is preferably at least 0.1 parts by mass and not more than 1 part by mass, with respect to 100 parts by mass of the resin component (C), from the viewpoint of the surface appearance of the molded article.

<Other Components>

In the reinforced thermoplastic resin composition of the present invention, if necessary, other modifiers, mold releasing agents, light or heat stabilizers, antistatic agents, dyes, pigments or the like may be blended.

<Method of Producing Reinforced Thermoplastic Resin Composition>

The reinforced thermoplastic resin composition of the present invention includes the polycarbonate resin (A), the graft copolymer (B), the glass fiber (D), the glycidyl ether unit-containing polymer (E), the phosphoric acid ester-based flame retardant (F), the sulfonic acid metal salt (G), and other components, if necessary, and, more specifically, can be obtained by mixing these components using a mixing device (for example, a Henschel mixer, tumbler mixer, Nauta mixer or the like). Furthermore, these components may be kneaded using a kneading device (for example, a single screw extruder, a twin screw extruder, a Banbury mixer, a co-kneader, or the like), or, if required, each raw material may be independently supplied to and kneaded by the kneading device.

It should be noted that the temperature during mixing and the mixing time can be adjusted arbitrarily depending on the ratio of the raw material to be supplied and the supply amount per unit time.

<Operation and Effect>

Since the reinforced thermoplastic resin composition of the present invention described above contains the polycarbonate resin (A), the graft copolymer (B), the glass fiber (D), the glycidyl ether unit-containing polymer (E), the phosphoric acid ester-based flame retardant (F) and the sulfonic acid metal salt (G) in a specific ratio, the moldability is favorable and the flame retardancy, rigidity, impact resistance, mechanical strength and heat resistance of the resulting molded article can be increased.

[Molded Article]

The molded article of the present invention is a molded article obtained through molding processing of the reinforced thermoplastic resin composition of the present invention.

As another aspect of the present invention, the molded article of the present invention includes the reinforced thermoplastic resin composition of the present invention.

Examples of the molding processing method of the reinforced thermoplastic resin composition include an injection molding method, an injection compression molding method, an extrusion method, a blow molding method, a vacuum molding method, an air-pressure molding method, a calendar molding method and an inflation molding method. Among these, an injection molding method and an injection compression molding method are preferred from the viewpoints of their excellent mass productivity and capability of yielding molded articles of highly precise dimensions.

The molded article of the present invention can be applied to, for example: housings of a personal computer (including a laptop type and a tablet type), a projector (including a liquid crystal projector), a television set, a printer, a fax machine, a copying machine, audio equipment, a game machine, a camera (including a video camera, a digital camera and the like), video equipment (such as a video), a musical instrument, a mobile device (such as an electronic diary and a personal digital assistant (PDA)), lighting equipment, a communication device (such as a telephone (including a mobile phone and a smartphone)) and the like; fishing tackles; play equipment (such as pinball goods); products for vehicles; products for furniture; sanitary products; products for building materials and the like. Among these applications, from the viewpoint that the effects of the present invention become particularly prominent, it is suitable for the housing of a mobile device (laptop and tablet personal computers, mobile devices including smartphones and the like).

As other aspects of the present invention,

a reinforced thermoplastic resin composition including: a polycarbonate resin (A) obtained from a dihydroxyarylalkane;

a graft copolymer (B) obtained by polymerizing a monomer mixture containing at least one component selected from the group consisting of styrene, α-methylstyrene and vinyltoluene, and at least one component selected from the group consisting of acrylonitrile and methacrylonitrile, in the presence of a butadiene rubber, styrene-butadiene rubber, acrylonitrile-butadiene rubber, acrylic rubber, diene-acrylic composite rubber or silicone-acrylic composite rubber;

a glass fiber (D) surface-treated with a water-soluble polyurethane and having a ratio between a major axis and a minor axis ((major axis)/(minor axis)) in a fiber cross section of at least 2 and not more than 6;

at least one component (E) (provided that the aforementioned graft copolymer (B) is excluded) selected from the group consisting of a bisphenol A type epoxy resin, a bisphenol F type epoxy resin, an epoxy resin having structures of both bisphenol A and bisphenol F, a phenol novolac type epoxy resin, a cresol novolac type epoxy resin and an epoxy group-containing phenoxy resin, and having a mass average molecular weight of 3,800 to 60,000;

a phosphoric acid ester-based flame retardant (F1) having a mass average molecular weight of 300 to 430;

a phosphoric acid ester-based flame retardant (F2) having a mass average molecular weight of 550 to 692; and

an alkali (earth) metal salt (G) of an aromatic sulfonic acid or perfluoroalkanesulfonic acid,

wherein

a content ratio of the aforementioned polycarbonate resin (A) is from 93 to 99% by mass with respect to a total mass of 100% by mass of the aforementioned polycarbonate resin (A) and the aforementioned graft copolymer (B);

a content ratio of the aforementioned graft copolymer (B) is from 1 to 7% by mass with respect to a total mass of 100% by mass of the aforementioned polycarbonate resin (A) and the aforementioned graft copolymer (B);

a content ratio of the aforementioned glass fiber (D) is from 30 to 50% by mass with respect to a total mass of 100% by mass of the aforementioned polycarbonate resin (A), the aforementioned graft copolymer (B), the aforementioned glass fiber (D), the aforementioned glycidyl ether unit-containing polymer (E), the aforementioned phosphoric acid ester-based flame retardant (F1), the aforementioned phosphoric acid ester-based flame retardant (F2) and the aforementioned sulfonic acid metal salt (G);

a content of the aforementioned glycidyl ether unit-containing polymer (E) is from 1 to 10 parts by mass with respect to a total of 100 parts by mass of the aforementioned polycarbonate resin (A) and the aforementioned graft copolymer (B);

a content of the aforementioned phosphoric acid ester-based flame retardant (F1) is from 0.5 to 5 parts by mass with respect to a total of 100 parts by mass of the aforementioned polycarbonate resin (A) and the aforementioned graft copolymer (B);

a content of the aforementioned phosphoric acid ester-based flame retardant (F2) is from 19.5 to 25 parts by mass with respect to a total of 100 parts by mass of the aforementioned polycarbonate resin (A) and the aforementioned graft copolymer (B);

a total of the content of the aforementioned phosphoric acid ester-based flame retardant (F1) and the content of the aforementioned phosphoric acid ester-based flame retardant (F2) is from 21 to 29 parts by mass with respect to a total of 100 parts by mass of the aforementioned polycarbonate resin (A) and the aforementioned graft copolymer (B); and

a content of the aforementioned sulfonic acid metal salt (G) is from 0.03 to 0.5 parts by mass with respect to a total of 100 parts by mass of the aforementioned polycarbonate resin (A) and the aforementioned graft copolymer (B), can be mentioned.

### EXAMPLES

Hereunder, specific examples are shown. The present invention is in no way limited by these Examples. In the following description, the units “parts” and “%” refer to “parts by mass” and “% by mass”, respectively.

<Measurement Method, Evaluation Method>

[Acetone Soluble Fraction]

2.5 g of a graft copolymer was immersed in 90 ml of acetone, heated at 65° C. for 3 hours, and then centrifuged at 1,500 rpm for 30 minutes by using a centrifugal separator. Then, the supernatant was removed and the residue was dried at 65° C. for 12 hours in a vacuum drier, and the resulting sample after drying was precisely weighed. From the mass difference (namely, (2.5 g)−(mass of the sample after drying)), the ratio (%) of the acetone soluble fraction in the graft copolymer was determined. The reduced viscosity of the acetone-soluble fraction was measured at 25° C. by adjusting with an N,N-dimethylformamide solution so that the concentration of the acetone-soluble fraction was 0.2 g/dl.

[Charpy Impact Strength]

The Charpy impact strength was measured in accordance with ISO 179.

[Flexural Strength and Flexural Modulus]

The flexural strength and the flexural modulus were measured in accordance with ISO 178. The flexural strength and the flexural modulus are indicators of the mechanical strength of the molded article.

[Flame Retardancy]

A test piece (having a width of 12.7 mm, a length of 127 mm and a thickness 0.8 mm) was prepared by molding a reinforced thermoplastic resin composition, and the flame retardancy was evaluated in the following manner in accordance with UL94.

A burner flame was applied to the lower end of the aforementioned test piece which was vertically supported and kept there for 10 seconds, and then the burner flame was removed from the test piece. After the flame was extinguished, the burner flame was reapplied and the same operation was carried out. Then, the evaluation was made based on the flaming combustion time after the first contact with the flame, the total of the second flaming combustion time and the flameless combustion time, and the presence or absence of fallen objects due to the combustion. The outline of the criteria for each grade in the UL94 standard is as follows.

V-0: The first flaming combustion time of not more than 10 seconds; the total of the second flaming combustion time and the flameless combustion time of not more than 30 seconds; with no fallen objects due to the combustion.

V-1: The first flaming combustion time of more than 10 seconds but not more than 30 seconds; the total of the second flaming combustion time and the flameless combustion time of more than 30 seconds but not more than 60 seconds; with no fallen objects due to the combustion.

V-2: The first flaming combustion time of more than 10 seconds but not more than 30 seconds; the total of the second flaming combustion time and the flameless combustion time of more than 30 seconds but not more than 60 seconds; with fallen objects due to the combustion.

The flame retardancy is expressed in tables by the following symbols.

A: The flame retardancy was in the V-0 level.

B: The flame retardancy was in the V-1 level.

C: The flame retardancy was in the V-2 level.

D: The flame retardancy was below the V-2 level.

[Heat Resistance]

The deflection temperature by the flatwise method was measured in accordance with ISO 75 using a load of 1.80 MPa.

[Moldability]

A liquid crystal display cover (having a thickness of 1 mm) for an A4 sized laptop personal computer was molded by an injection molding machine (J350E with a 350 t accumulator, manufactured by The Japan Steel Works, LTD.) under the molding conditions including the molding temperature of 290° C., the injection speed of 99% and the mold temperature of 85° C. The moldability was evaluated based on the presence or absence of short shot (unfilled portions) and the presence or absence of sink and gas burning during the molding.

A: No unfilled portion, sink or gas burning was observed.

B: Sink was partially observed.

C: Either one or both of unfilled portions and gas burning was observed.

<Each Component>

[Polycarbonate Resin (A)]

As a polycarbonate resin (A-1), NOVAREX 7021PJ (viscosity average molecular weight: 18,800) manufactured by Mitsubishi Engineering-Plastics Corporation was used.

[Production of Graft Copolymer (B1-1)]

A copolymer latex (2 parts in terms of solid content) having an average particle size of 0.08 μm consisting of 85% of an n-butyl acrylate unit and 15% of a methacrylic acid unit was added, with stirring, to a polybutadiene latex (100 parts in terms of solid content) having a solid content concentration of 35% and an average particle size of 0.08 μm. The resulting mixture was kept stirred for 30 minutes, thereby yielding an enlarged butadiene-based rubbery polymer latex having an average particle size of 0.28 μm.

The yielded enlarged butadiene-based rubbery polymer latex was placed in a reactor vessel, to which 100 parts of distilled water, 4 parts of a wood rosin emulsifier, 0.4 parts of DEMOL N (naphthalenesulfonic acid formalin condensate manufactured by Kao Corporation), 0.04 parts of sodium hydroxide and 0.7 parts of dextrose were added.

The aforementioned mixture was heated under stirring, and when the internal temperature reached 60° C., 0.1 part of ferrous sulfate, 0.4 parts of sodium pyrophosphate and 0.06 parts of sodium dithionite were added. Thereafter, a mixture containing the following components was continuously added dropwise over 90 minutes, and the resultant product was then allowed to stand for 1 hour to cool.

Acrylonitrile 30 parts

Styrene 70 parts

Cumene hydroperoxide 0.4 parts

tert-dodecyl mercaptan 1 part

The obtained graft copolymer latex was coagulated with dilute sulfuric acid, and the resultant was then washed, filtered and dried, thereby yielding a dry powder of the graft copolymer (B1-1).

The acetone-soluble fraction of the graft copolymer (B1-1) was 27%. In addition, the reduced viscosity of the acetone-soluble fraction was 0.3 dl/g.

[Production of Graft Copolymer (B1-2)]

Raw materials were charged into a reaction vessel in the following proportions and polymerized under stirring with nitrogen substitution at 50° C. for 4 hours, thereby yielding a rubber latex.

n-butyl acrylate 98 parts

1,3-butylene glycol dimethacrylate 1 part

Allyl methacrylate 1 part

Sodium dioctyl sulfosuccinate 2.0 parts

Deionized water 300 parts

Potassium persulfate 0.3 parts

Disodium phosphate dodecahydrate 0.5 parts

Sodium hydrogen phosphate dodecahydrate 0.3 parts

The yielded rubber latex (100 parts in terms of solid content) was charged into a separate reaction vessel and diluted by adding 280 parts of ion exchanged water thereto, and the resulting product was heated to 70° C.

Separately, 0.7 parts of benzoyl peroxide was dissolved in 100 parts of a monomer mixture composed of acrylonitrile/styrene=29/71 (mass ratio), and the resulting mixture was subjected to nitrogen substitution. Then, the resulting monomer mixture was added at a rate of 30 parts/hour by a metering pump into the reactor vessel which contained the aforementioned rubber latex. After adding all of the monomer mixture, the temperature inside the reaction vessel was raised to 80° C., and the resulting mixture was kept stirred for 30 minutes, thereby yielding a graft copolymer latex. The polymerization rate was 99%.

The graft copolymer latex was charged into a coagulation bath which contained a 0.15% aqueous solution of aluminum chloride (AlCl3.6H2O) (90° C.) at a three times greater amount than the total amount of the latex, under stirring to effect coagulation. After all the latex was added, the temperature inside the coagulation bath was raised to 93° C., and the resulting mixture was allowed to stand for 5 minutes. The resultant was cooled and then liquid was removed therefrom by a centrifugal separator, and the resulting product was washed and then dried, thereby yielding a dry powder of the graft copolymer (B1-2).

The acetone-soluble fraction of the graft copolymer (B1-2) was 21%. In addition, the reduced viscosity of the acetone-soluble fraction was 0.70 dl/g.

[Production of Graft Copolymer (B1-3)]

A graft copolymer (B1-3) including a composite rubber of polybutadiene/polybutyl acrylate as a rubbery polymer was obtained by the method described below.

A copolymer latex (0.4 parts in terms of solid content) having an average particle size of 0.10 μm consisting of 82% of an n-butyl acrylate unit and 18% of a methacrylic acid unit was added, with stirring, to a polybutadiene latex (20 parts in terms of solid content) having a solid content concentration of 35% and an average particle size of 0.08 μm. The resulting mixture was kept stirred for 30 minutes, thereby yielding an enlarged diene-based rubber latex having an average particle size of 0.36 μm.

The yielded enlarged diene-based rubber latex (20 parts in terms of solid content) was placed in a reaction vessel, and 1 part of disproportionated potassium rosinate, 150 parts of ion exchanged water and a monomer mixture having the following composition were added thereto. The resulting product was subjected to nitrogen substitution and then heated to 50° C. (internal temperature). Furthermore, a solution prepared by dissolving 0.0002 parts of ferrous sulfate, 0.0006 parts of disodium ethylenediaminetetraacetate, and 0.25 parts of Rongalite in 10 parts of ion exchanged water was added into the reaction vessel, to effect a reaction.

n-butyl acrylate 80 parts

Allyl methacrylate 0.32 parts

Ethylene glycol dimethacrylate 0.16 parts

The internal temperature at the completion of the reaction was 75° C. The resulting solution was further heated to 80° C., and the reaction was continued for 1 hour, thereby yielding a composite rubber of an enlarged diene-based rubber and a polybutyl acrylate-based rubber. The polymerization rate was 98.8%.

The composite rubber latex (50 parts in terms of solid content) of the enlarged diene-based rubber and the polybutyl acrylate-based rubber was placed in a reaction vessel and was then diluted by adding 140 parts of ion exchanged water thereto, and the resultant was heated to 70° C.

Separately, 0.35 parts of benzoyl peroxide were dissolved in 50 parts of a monomer mixture composed of acrylonitrile/styrene=29/71 (mass ratio), followed by nitrogen substitution. The monomer mixture was added at a rate of 15 parts/hour by a metering pump into the reactor vessel which contained the aforementioned rubber latex. After adding all of the monomer mixture, the temperature inside the reaction vessel was raised to 80° C., and the resulting mixture was kept stirred for 30 minutes, thereby yielding a graft copolymer latex. The polymerization rate was 99%.

The graft copolymer latex was charged into a coagulation bath which contained a 0.5% aqueous solution of sulfuric acid (90° C.) at a three times greater amount than the total amount of the latex, under stirring to effect coagulation. After all the latex was added, the temperature inside the coagulation bath was raised to 93° C., and the resulting mixture was allowed to stand for 5 minutes. The resultant was cooled and then liquid was removed therefrom by a centrifugal separator, and the resulting product was washed and then dried, thereby yielding a dry powder of the graft copolymer (B1-3).

The acetone-soluble fraction of the graft copolymer (B1-3) was 20%. In addition, the reduced viscosity of the acetone-soluble fraction was 0.7 dl/g.

[Production of Graft Copolymer (B1-4)]

A graft copolymer (B1-4) including a composite rubber of polysiloxane rubber/polybutyl acrylate as a rubbery polymer was obtained by the method described below.

96 parts of octamethyltetracyclosiloxane, 2 parts of γ-methacryloxypropyldimethoxymethylsilane and 2 parts of ethyl orthosilicate were mixed to yield 100 parts of a siloxane-based mixture. 300 parts of distilled water having 0.67 parts of sodium dodecylbenzene sulfonate dissolved therein were added to this mixture. The resulting mixture was stirred by a homomixer at 10,000 rpm for 2 minutes, and was then homogenized once at a pressure of 30 MPa by a homogenizer, thereby yielding a stable premixed organosiloxane latex.

2 parts of dodecylbenzenesulfonic acid and 98 parts of distilled water were charged into a reaction vessel equipped with a reagent infusion container, a cooling tube, a jacket heater and a stirring device, by which a 2% aqueous solution of dodecylbenzenesulfonic acid was prepared. While heating this aqueous solution to 85° C., the premixed organosiloxane latex was dropwise added thereto over 4 hours. After the completion of the dropwise addition, the resulting mixture was kept at this temperature for 1 hour, and was then cooled. The reaction solution was allowed to stand at room temperature for 48 hours, and then neutralized with an aqueous solution of sodium hydroxide, thereby yielding a polyorganosiloxane latex (L-1). A portion of the polyorganosiloxane latex (L-1) was dried at 170° C. for 30 minutes to obtain the solid content concentration, which was 17.3%.

119.5 parts of the polyorganosiloxane latex (L-1) and 0.8 parts of sodium polyoxyethylene alkyl phenyl ether sulfate were charged into a reaction vessel equipped with a reagent injection container, a cooling tube, a jacket heater and a stirring device, and 203 parts of distilled water was added and mixed therein.

Then, a mixture composed of 53.2 parts of n-butyl acrylate, 0.21 parts of allyl methacrylate, 0.11 parts of 1,3-butylene glycol dimethacrylate, and 0.13 parts of tertiary butyl hydroperoxide was added thereto. A nitrogen gas was let to flow through this reaction vessel so as to substitute the inside atmosphere with nitrogen, and the temperature was raised to 60° C. When the internal temperature of the reaction vessel reached 60° C., an aqueous solution prepared by dissolving 0.0001 parts of ferrous sulfate, 0.0003 parts of disodium ethylenediaminetetraacetate and 0.24 parts of Rongalite in 10 parts of distilled water was added to initiate radical polymerization. Due to the polymerization of the acrylate components, the temperature of the solution increased to 78° C. This state was maintained for 1 hour to complete the polymerization of the acrylate components, thereby yielding a composite rubber latex of polyorganosiloxane and a butyl acrylate rubber.

After the solution temperature inside the reaction vessel decreased to 60° C., an aqueous solution obtained by dissolving 0.4 parts of Rongalite in 10 parts of distilled water was added thereto. Subsequently, a mixed solution including 11.1 parts of acrylonitrile, 33.2 parts of styrene, and 0.2 parts of tertiary butyl hydroperoxide was dropwise added thereto over about 1 hour to effect polymerization. After the completion of the dropwise addition, the resulting mixture was allowed to stand for 1 hour, and an aqueous solution prepared by dissolving 0.0002 parts of ferrous sulfate, 0.0006 parts of disodium ethylenediaminetetraacetate, and 0.25 parts of Rongalite in 10 parts of distilled water was then added thereto. Subsequently, a mixed solution including 7.4 parts of acrylonitrile, 22.2 parts of styrene, and 0.1 parts of tertiary butyl hydroperoxide was dropwise added thereto over about 40 minutes to effect polymerization. After the completion of the dropwise addition, the resulting mixture was allowed to stand for 1 hour, and was then cooled, thereby yielding a graft copolymer latex in which an acrylonitrile-styrene copolymer was grafted onto the composite rubber composed of polyorganosiloxane and the butyl acrylate rubber.

150 parts of an aqueous solution prepared by dissolving calcium acetate in a proportion of 5% was heated to 60° C. and stirred.

100 parts of the graft copolymer latex was gradually dropwise added into the aqueous solution of calcium acetate to effect coagulation. The resulting coagulated product was separated, washed, and then dried, thereby yielding a dry powder of the graft copolymer (B1-4).

The acetone-soluble fraction of the graft copolymer (B1-4) was 26%. In addition, the reduced viscosity of the acetone-soluble fraction was 0.60 dl/g.

[Glass Fiber (D)]

As a glass fiber (D-1), a chopped glass fiber (CSG 3PA-820 manufactured by Nitto Boseki Co., Ltd., surface treatment agent: water-soluble polyurethane, ratio of (major axis)/(minor axis): 4) was used.

As a glass fiber (D-2), a chopped glass fiber (CSH 3PA-870 manufactured by Nitto Boseki Co., Ltd., surface treatment agent: water-soluble polyurethane, ratio of (major axis)/(minor axis): 2) was used.

As a glass fiber (D-3), a chopped glass fiber (CSH 3PA-850 manufactured by Nitto Boseki Co., Ltd., surface treatment agent: water-soluble epoxy resin, ratio of (major axis)/(minor axis): 2) was used.

As a glass fiber (D-4), a chopped glass fiber (CS 3PE-455 manufactured by Nitto Boseki Co., Ltd., surface treatment agent: water-soluble polyurethane, ratio of (major axis)/(minor axis): 1) was used.

[Glycidyl Ether Unit-Containing Polymer (E)]

As a glycidyl ether unit-containing polymer (E-1), an epoxy group-containing phenoxy resin (jER4250 manufactured by Mitsubishi Chemical Corporation, mass average molecular weight: 60,000) was used.

As a glycidyl ether unit-containing polymer (E-2), an epoxy group-containing phenoxy resin (jER1256 manufactured by Mitsubishi Chemical Corporation, mass average molecular weight: 50,000) was used.

As a glycidyl ether unit-containing polymer (E-3), a bisphenol A type epoxy resin (jER1010 manufactured by Mitsubishi Chemical Corporation, mass average molecular weight: 5,500) was used.

As a glycidyl ether unit-containing polymer (E-4), a bisphenol A type epoxy resin (jER1009 manufactured by Mitsubishi Chemical Corporation, mass average molecular weight: 3,800) was used.

As a glycidyl ether unit-containing polymer (E-5), a bisphenol A type epoxy resin (jER1004 manufactured by Mitsubishi Chemical Corporation, mass average molecular weight: 1,650) was used.

[Production of Gycidyl Eher Unit-Containing Polymer (E-6)]

In a separable flask having a volume of 500 ml and equipped with a stirring device, a thermometer, a nitrogen inlet and a cooling tube, 82.42 parts of a bisphenol A type epoxy resin (epoxy equivalent: 467 g/eq), 6.3 parts of a bisphenol A type liquid epoxy resin (epoxy equivalent: 210 g/eq, hydrolyzable chlorine: 1.79%), 13.95 parts of bisphenol A, 19.6 parts of p-cumylphenol, 7.5 parts of a polyester resin (GV-335 manufactured by Japan U-PICA Co., Ltd., acid value: 30 KOHmg/g), and 30 parts of xylene were charged, and the resulting mixture was heated to increase the temperature under a nitrogen atmosphere.

When the internal temperature of the reaction system reached 80° C., 0.18 parts of a 5% aqueous solution of lithium chloride was added thereto, and the temperature was further increased. When the internal temperature of the reaction system reached 130° C., the pressure inside the reaction system was reduced to remove xylene and water out of the system. A reaction was conducted while maintaining the reaction temperature at 160° C., and the internal pressure of the reaction system was returned to normal pressure by introducing nitrogen into the reaction system after 1 hour. At the point where 7 hours had elapsed from the time when the reaction temperature reached 160° C., 20.25 parts of a high molecular weight bisphenol A type epoxy resin (epoxy equivalent: 2,700 g/eq) were added thereto. After stirring the resulting mixture for 1 hour, 100 parts of a polyester resin (GV-730 manufactured by Japan U-PICA Co., Ltd., acid value: 3 KOHmg/g) were added thereto, and the reaction was allowed to proceed for 10 hours at 180° C., thereby yielding a high molecular weight epoxy resin. In order to subject the resulting high molecular weight epoxy resin to the molecular weight measurement by GPC, an attempt was made to dissolve 0.1 g of a sample in 10 ml of tetrahydrofuran. As a result, about 0.05 g thereof was insoluble. After filtration through a 5 C filter paper, the resulting filtrate was subjected to the molecular weight measurement by GPC, as a result of which the mass average molecular weight was 70,200.

[Phosphoric Acid Ester-Based Flame Retardant (F)]

As a phosphoric acid ester-based flame retardant (F1-1), triphenyl phosphate (TPP manufactured by Daihachi Chemical Industry Co., Ltd., mass average molecular weight: 326, catalog value) was used.

As a phosphoric acid ester-based flame retardant (F1-2), trixylyl phosphate (PX-130 manufactured by Daihachi Chemical Industry Co., Ltd., mass average molecular weight: 410, catalog value) was used.

As a phosphoric acid ester-based flame retardant (F2-1), phenylenebis(dixylyl phosphate) (PX-200 manufactured by Daihachi Chemical Industry Co., Ltd., mass average molecular weight: 686, catalog value) was used.

As a phosphoric acid ester-based flame retardant (F2-2), phenylenebis(diphenyl phosphate) (CR-733S manufactured by Daihachi Chemical Industry Co., Ltd., mass average molecular weight: 574, catalog value) was used.

As a phosphoric acid ester-based flame retardant (F2-3), bisphenol A bis(diphenyl phosphate) (BAPP manufactured by Ajinomoto Fine-Techno Co., Inc., mass average molecular weight: 692, catalog value) was used.

[Sulfonic Acid Metal Salt (G)]

As a sulfonic acid metal salt (G-1), potassium perfluorobutane sulfonate (Chemguard-411 manufactured by Sun Chemical Company Ltd.) was used.

As a sulfonic acid metal salt (G-2), sodium para-toluene sulfonate (Chemguard-NATS manufactured by Sun Chemical Company Ltd.) was used.

As a sulfonic acid metal salt (G-3), potassium diphenyl sulfone sulfonate (Chemguard-KSS manufactured by Sun Chemical Company Ltd.) was used.

[Flame Retardant Auxiliary Agent (I)]

As a flame retardant auxiliary agent (I-1), polytetrafluoroethylene (PTFE) was used.

### Examples 1 to 28, Comparative Examples 1 to 23

Each of the components described above was mixed, as indicated in Tables 1 to 8, to obtain a reinforced thermoplastic resin composition.

The moldability of the resulting reinforced thermoplastic resin compositions and the Charpy impact strength, flexural strength, flexural modulus, flame retardancy and heat resistance of the resulting molded articles were evaluated. The evaluation results are shown in Tables 1 to 8.

TABLE 1

| | | | | Example No. | | | | | | |
|---|---|---|---|---|---|---|---|---|---|---|
| | | | | 1 | 2 | 3 | 4 | 5 | 6 | 7 |
| Reinforced | C | A-1 | % | 93 | 94 | 95 | 98 | 99 | 95 | 95 |
| thermoplastic | | B1-1 | % | | | | | | | |
| resin | | B1-2 | % | | | | | | | |
| composition | | B1-3 | % | | | | | | | |
| | | B1-4 | % | 7 | 6 | 5 | 2 | 1 | 5 | 5 |

| E-1 | Parts | | | | | | 8 | |
|---|---|---|---|---|---|---|---|---|
| E-2 | Parts | 8 | 8 | 8 | 8 | 8 | | |
| E-3 | Parts | | | | | | | 8 |
| E-4 | Parts | | | | | | | |
| E-5 | Parts | | | | | | | |
| E-6 | Parts | | | | | | | |
| F1-1 | Parts | 1 | 1 | 1 | 1 | 1 | 1 | 1 |
| F1-2 | Parts | | | | | | | |
| F2-1 | Parts | 22 | 22 | 22 | 22 | 22 | 22 | 22 |
| F2-2 | Parts | | | | | | | |
| F2-3 | Parts | | | | | | | |
| G-1 | Parts | 0.05 | 0.05 | 0.05 | 0.05 | 0.05 | 0.05 | 0.05 |
| G-2 | Parts | | | | | | | |
| G-3 | Parts | | | | | | | |
| I-1 | Parts | 0.8 | | | | | | |
| D-1 | Parts | 108 | 108 | 108 | 108 | 108 | 108 | 108 |
| D-2 | Parts | | | | | | | |
| D-3 | Parts | | | | | | | |
| D-4 | Parts | | | | | | | |
| Ratio of D in | % | 45 | 45 | 45 | 45 | 45 | 45 | 45 |
| reinforced | | | | | | | | |
| thermoplastic | | | | | | | | |
| resin | | | | | | | | |
| composition | | | | | | | | |

| | | | | | | | | |
|---|---|---|---|---|---|---|---|---|
| Charpy impact | kJ/m² | 15 | 17 | 18 | 16 | 15 | 17 | 17 |
| strength | | | | | | | | |
| Flexural strength | MPa | 224 | 225 | 245 | 241 | 238 | 224 | 232 |
| Flexural modulus | MPa | 13100 | 13200 | 13500 | 13600 | 13700 | 12900 | 13000 |
| Flame retardancy | — | A | A | A | A | A | A | A |
| Heat resistance | ° C. | 95 | 95 | 96 | 97 | 98 | 96 | 96 |
| Moldability | — | A | A | A | A | A | A | A |

TABLE 2

| | | | | Example No. | | | | | | |
|---|---|---|---|---|---|---|---|---|---|---|
| | | | | 8 | 9 | 10 | 11 | 12 | 13 | 14 |
| Reinforced | C | A-1 | % | 95 | 95 | 95 | 95 | 95 | 95 | 95 |
| thermoplastic | | B1-1 | % | | 5 | | | | | |
| resin | | B1-2 | % | | | 5 | | | | |
| composition | | B1-3 | % | | | | 5 | | | |
| | | B1-4 | % | 5 | | | | 5 | 5 | 5 |

| E-1 | Parts | | | | | | | |
|---|---|---|---|---|---|---|---|---|
| E-2 | Parts | | 8 | 8 | 8 | 8 | 8 | 8 |
| E-3 | Parts | | | | | | | |
| E-4 | Parts | 8 | | | | | | |
| E-5 | Parts | | | | | | | |
| E-6 | Parts | | | | | | | |
| F1-1 | Parts | 1 | 1 | 1 | 1 | 5 | 0.5 | 1 |
| F1-2 | Parts | | | | | | | |
| F2-1 | Parts | 22 | 22 | 22 | 22 | 20 | 25 | 22 |
| F2-2 | Parts | | | | | | | |
| F2-3 | Parts | | | | | | | |
| G-1 | Parts | 0.05 | 0.05 | 0.05 | 0.05 | 0.05 | 0.05 | 0.05 |
| G-2 | Parts | | | | | | | |
| G-3 | Parts | | | | | | | |
| I-1 | Parts | 0.8 | | | | | | |
| D-1 | Parts | 108 | 108 | 108 | 108 | 110 | 109 | 61 |
| D-2 | Parts | | | | | | | |
| D-3 | Parts | | | | | | | |
| D-4 | Parts | | | | | | | |
| Ratio of D in | % | 45 | 45 | 45 | 45 | 45 | 45 | 45 |
| reinforced | | | | | | | | |
| thermoplastic | | | | | | | | |
| resin | | | | | | | | |
| composition | | | | | | | | |

| | | | | | | | | |
|---|---|---|---|---|---|---|---|---|
| Charpy impact strength | kJ/m² | 15 | 17 | 17 | 17 | 18 | 17 | 15 |
| Flexural strength | MPa | 225 | 237 | 242 | 247 | 238 | 249 | 199 |
| Flexural modulus | MPa | 13000 | 13500 | 13400 | 13400 | 12600 | 13600 | 8700 |
| Flame retardancy | — | A | B | B | B | A | A | A |
| Heat resistance | ° C. | 96 | 96 | 96 | 96 | 95 | 92 | 96 |
| Moldability | — | A | A | A | A | A | A | A |

TABLE 3

| | | | | Example No. | | | | | | |
|---|---|---|---|---|---|---|---|---|---|---|
| | | | | 15 | 16 | 17 | 18 | 19 | 20 | 21 |
| Reinforced | C | A-1 | % | 95 | 95 | 95 | 95 | 95 | 95 | 95 |
| thermoplastic | | B1-1 | % | | | | | | | |
| resin | | B1-2 | % | | | | | | | |
| composition | | B1-3 | % | | | | | | | |
| | | B1-4 | % | 5 | 5 | 5 | 5 | 5 | 5 | 5 |

| E-1 | Parts | | | | | | | |
|---|---|---|---|---|---|---|---|---|
| E-2 | Parts | 8 | 8 | 8 | 8 | 8 | 1 | 3 |
| E-3 | Parts | | | | | | | |
| E-4 | Parts | | | | | | | |
| E-5 | Parts | | | | | | | |
| E-6 | Parts | | | | | | | |
| F1-1 | Parts | 1 | 1 | 1 | | 1 | 1 | 1 |
| F1-2 | Parts | | | | 1 | | | |
| F2-1 | Parts | 22 | 22 | | 22 | | 22 | 22 |
| F2-2 | Parts | | | 22 | | | | |
| F2-3 | Parts | | | | | 22 | | |
| G-1 | Parts | 0.05 | 0.05 | 0.05 | 0.05 | 0.05 | 0.05 | 0.05 |
| G-2 | Parts | | | | | | | |
| G-3 | Parts | | | | | | | |
| I-1 | Parts | 0.8 | | | | | | |
| D-1 | Parts | 88 | 132 | 108 | 108 | 108 | 103 | 103 |
| D-2 | Parts | | | | | | | |
| D-3 | Parts | | | | | | | |
| D-4 | Parts | | | | | | | |
| Ratio of D in | % | 40 | 50 | 45 | 45 | 45 | 45 | 45 |
| reinforced | | | | | | | | |
| thermoplastic | | | | | | | | |
| resin | | | | | | | | |
| composition | | | | | | | | |

| | | | | | | | | |
|---|---|---|---|---|---|---|---|---|
| Charpy impact | kJ/m² | 17 | 19 | 19 | 18 | 18 | 15 | 16 |
| strength | | | | | | | | |
| Flexural strength | MPa | 231 | 259 | 245 | 245 | 242 | 208 | 225 |
| Flexural modulus | MPa | 12100 | 14900 | 13500 | 13500 | 13500 | 12800 | 13200 |
| Flame retardancy | — | A | A | A | A | B | A | A |
| Heat resistance | ° C. | 96 | 95 | 96 | 96 | 96 | 96 | 96 |
| Moldability | — | A | B | A | A | A | A | A |

TABLE 4

| | | | | Example No. | | | | | | |
|---|---|---|---|---|---|---|---|---|---|---|
| | | | | 22 | 23 | 24 | 25 | 26 | 27 | 28 |
| Reinforced | C | A-1 | % | 95 | 95 | 95 | 95 | 95 | 95 | 95 |
| thermoplastic | | B1-1 | % | | | | | | | |
| resin | | B1-2 | % | | | | | | | |
| composition | | B1-3 | % | | | | | | | |
| | | B1-4 | % | 5 | 5 | 5 | 5 | 5 | 5 | 5 |

| E-1 | Parts | | | | | | | |
|---|---|---|---|---|---|---|---|---|
| E-2 | Parts | 10 | 8 | 8 | 8 | 8 | 8 | 8 |
| E-3 | Parts | | | | | | | |
| E-4 | Parts | | | | | | | |
| E-5 | Parts | | | | | | | |
| E-6 | Parts | | | | | | | |
| F1-1 | Parts | 1 | 1 | 1 | 1 | 1 | 1 | 1 |
| F1-2 | Parts | | | | | | | |
| F2-1 | Parts | 22 | 22 | 22 | 22 | 22 | 22 | 22 |
| F2-2 | Parts | | | | | | | |
| F2-3 | Parts | | | | | | | |
| G-1 | Parts | 0.05 | | | 0.03 | 0.2 | 0.5 | 0.05 |
| G-2 | Parts | | 0.05 | | | | | |
| G-3 | Parts | | | 0.05 | | | | |
| I-1 | Parts | 0.8 | | | | | | |
| D-1 | Parts | 106 | 108 | 108 | 108 | 108 | 108 | |
| D-2 | Parts | | | | | | | 108 |
| D-3 | Parts | | | | | | | |
| D-4 | Parts | | | | | | | |
| Ratio of D in | % | 45 | 45 | 45 | 45 | 45 | 45 | 45 |
| reinforced | | | | | | | | |
| thermoplastic | | | | | | | | |
| resin | | | | | | | | |
| composition | | | | | | | | |

| | | | | | | | | |
|---|---|---|---|---|---|---|---|---|
| Charpy impact | kJ/m² | 19 | 17 | 16 | 18 | 18 | 16 | 16 |
| strength | | | | | | | | |
| Flexural strength | MPa | 260 | 244 | 245 | 245 | 245 | 245 | 228 |
| Flexural modulus | MPa | 13800 | 13600 | 13500 | 13500 | 13500 | 13500 | 13200 |
| Flame retardancy | — | B | A | A | B | A | B | A |
| Heat resistance | ° C. | 96 | 96 | 97 | 96 | 96 | 95 | 96 |
| Moldability | — | B | A | A | A | A | A | A |

TABLE 5

| | | | | Comparative Example No. | | | | | |
|---|---|---|---|---|---|---|---|---|---|
| | | | | 1 | 2 | 3 | 4 | 5 | 6 |
| Reinforced thermoplastic | C | A-1 | % | 92 | 100 | 95 | 95 | 93 | 93 |
| resin composition | | B1-1 | % | | | | | | |
| | | B1-2 | % | | | | | | |
| | | B1-3 | % | | | | | | |
| | | B1-4 | % | 8 | | 5 | 5 | 7 | 7 |

| E-1 | Parts | | | | | | |
|---|---|---|---|---|---|---|---|
| E-2 | Parts | 8 | 8 | 8 | 8 | 8 | 8 |
| E-3 | Parts | | | | | | |
| E-4 | Parts | | | | | | |
| E-5 | Parts | | | | | | |
| E-6 | Parts | | | | | | |
| F1-1 | Parts | 1 | 1 | 1 | 1 | 1 | 1 |
| F1-2 | Parts | | | | | | |
| F2-1 | Parts | 22 | 22 | 22 | 22 | 22 | 22 |
| F2-2 | Parts | | | | | | |
| F2-3 | Parts | | | | | | |
| G-1 | Parts | 0.05 | 0.05 | 0.05 | 0.05 | 0.05 | 0.05 |
| G-2 | Parts | | | | | | |
| G-3 | Parts | | | | | | |
| I-1 | Parts | 0.8 | | | | | |
| D-1 | Parts | 107 | 107 | 56 | 142 | | |
| D-2 | Parts | | | | | | |
| D-3 | Parts | | | | | 107 | |
| D-4 | Parts | | | | | | 107 |
| Ratio of D in | % | 45 | 45 | 29 | 52 | 45 | 45 |
| reinforced | | | | | | | |
| thermoplastic resin | | | | | | | |
| composition | | | | | | | |

| | | | | | | | |
|---|---|---|---|---|---|---|---|
| Charpy impact strength | kJ/m² | 12 | 12 | 15 | 19 | 12 | 11 |
| Flexural strength | MPa | 223 | 234 | 196 | 262 | 202 | 198 |
| Flexural modulus | MPa | 12900 | 13800 | 8400 | 15200 | 12300 | 12300 |
| Flame retardancy | — | A | A | A | A | A | A |
| Heat resistance | ° C. | 95 | 99 | 96 | 95 | 95 | 95 |
| Moldability | — | A | C | A | C | A | C |

TABLE 6

| | | | | Comparative Example No. | | | | | |
|---|---|---|---|---|---|---|---|---|---|
| | | | | 7 | 8 | 9 | 10 | 11 | 12 |
| Reinforced thermoplastic | C | A-1 | % | 93 | 93 | 93 | 93 | 93 | 95 |
| resin composition | | B1-1 | % | | | | | | |
| | | B1-2 | % | | | | | | |
| | | B1-3 | % | | | | | | |
| | | B1-4 | % | 7 | 7 | 7 | 7 | 7 | 5 |

| E-1 | Parts | | | | | | |
|---|---|---|---|---|---|---|---|
| E-2 | Parts | 8 | 8 | 0.5 | 11 | 8 | 8 |
| E-3 | Parts | | | | | | |
| E-4 | Parts | | | | | | |
| E-5 | Parts | | | | | | |
| E-6 | Parts | | | | | | |
| F1-1 | Parts | 1 | 0.4 | 1 | 1 | 1 | 1 |
| F1-2 | Parts | | | | | | |
| F2-1 | Parts | 18 | 22 | 22 | 22 | 22 | 22 |
| F2-2 | Parts | | | | | | |
| F2-3 | Parts | | | | | | |
| G-1 | Parts | 0.05 | 0.05 | 0.05 | 0.05 | 0.02 | 0.6 |
| G-2 | Parts | | | | | | |
| G-3 | Parts | | | | | | |
| I-1 | Parts | 0.8 | | | | | |
| D-1 | Parts | 105 | 107 | 102 | 108 | 108 | 108 |
| D-2 | Parts | | | | | | |
| D-3 | Parts | | | | | | |
| D-4 | Parts | | | | | | |
| Ratio of D in | % | 45 | 45 | 45 | 45 | 45 | 45 |
| reinforced | | | | | | | |
| thermoplastic resin | | | | | | | |
| composition | | | | | | | |

| | | | | | | | |
|---|---|---|---|---|---|---|---|
| Charpy impact strength | kJ/m² | 16 | 15 | 10 | 19 | 15 | 15 |
| Flexural strength | MPa | 218 | 223 | 197 | 270 | 224 | 245 |
| Flexural modulus | MPa | 12900 | 12900 | 12800 | 13900 | 13100 | 13500 |
| Flame retardancy | — | D | D | A | D | D | C |
| Heat resistance | ° C. | 95 | 94 | 94 | 96 | 95 | 94 |
| Moldability | — | A | A | A | C | A | A |

TABLE 7

| | | | | Comparative Example No. | | | | | |
|---|---|---|---|---|---|---|---|---|---|
| | | | | 13 | 14 | 15 | 16 | 17 | 18 |
| Reinforced thermoplastic | C | A-1 | % | 95 | 95 | 95 | 95 | 95 | 95 |
| resin composition | | B1-1 | % | | | | | | |
| | | B1-2 | % | | | | | | |
| | | B1-3 | % | | | | | | |
| | | B1-4 | % | 5 | 5 | 5 | 5 | 5 | 5 |

| E-1 | Parts | | | | | | |
|---|---|---|---|---|---|---|---|
| E-2 | Parts | 8 | 8 | 8 | 8 | | |
| E-3 | Parts | | | | | | |
| E-4 | Parts | | | | | | |
| E-5 | Parts | | | | | 8 | |
| E-6 | Parts | | | | | | 8 |
| F1-1 | Parts | 1 | | | | 1 | 1 |
| F1-2 | Parts | | | | | | |
| F2-1 | Parts | 22 | 22 | 22 | 31 | 22 | 22 |
| F2-2 | Parts | | | | | | |
| F2-3 | Parts | | | | | | |
| G-1 | Parts | | 0.05 | | | 0.05 | 0.05 |
| G-2 | Parts | | | | | | |
| G-3 | Parts | | | | | | |
| I-1 | Parts | 0.8 | | | | | |
| D-1 | Parts | 108 | 108 | 107 | 114 | 108 | 108 |
| D-2 | Parts | | | | | | |
| D-3 | Parts | | | | | | |
| D-4 | Parts | | | | | | |
| Ratio of D in | % | 45 | 45 | 45 | 45 | 45 | 45 |
| reinforced | | | | | | | |
| thermoplastic resin | | | | | | | |
| composition | | | | | | | |

| | | | | | | | |
|---|---|---|---|---|---|---|---|
| Charpy impact strength | kJ/m² | 18 | 18 | 18 | 16 | 13 | 17 |
| Flexural strength | MPa | 245 | 244 | 244 | 257 | 197 | 222 |
| Flexural modulus | MPa | 13500 | 13300 | 13300 | 13200 | 13100 | 13000 |
| Flame retardancy | — | B | B | B | C | A | D |
| Heat resistance | ° C. | 94 | 96 | 96 | 83 | 96 | 96 |
| Moldability | — | B | B | B | A | A | C |

TABLE 8

| | | | | Comparative Example No. | | | | |
|---|---|---|---|---|---|---|---|---|
| | | | | 19 | 20 | 21 | 22 | 23 |
| Reinforced thermoplastic | C | A-1 | % | 95 | 95 | 95 | 95 | 95 |
| resin composition | | B1-1 | % | | | | | |
| | | B1-2 | % | | | | | |
| | | B1-3 | % | | | | | |
| | | B1-4 | % | 5 | 5 | 5 | 5 | 5 |

| E-1 | Parts | | | | | |
|---|---|---|---|---|---|---|
| E-2 | Parts | 8 | 8 | 8 | 8 | 8 |
| E-3 | Parts | | | | | |
| E-4 | Parts | | | | | |
| E-5 | Parts | | | | | |
| E-6 | Parts | | | | | |
| F1-1 | Parts | | 0.5 | 5 | 6 | 4 |
| F1-2 | Parts | | | | | |
| F2-1 | Parts | 23 | 19.5 | 25 | 24 | 26 |
| F2-2 | Parts | | | | | |
| F2-3 | Parts | | | | | |
| G-1 | Parts | 0.05 | 0.05 | 0.05 | 0.05 | 0.05 |
| G-2 | Parts | | | | | |
| G-3 | Parts | | | | | |
| I-1 | Parts | 0.8 | | | | |
| D-1 | Parts | 108 | 114 | 114 | 114 | 114 |
| D-2 | Parts | | | | | |
| D-3 | Parts | | | | | |
| D-4 | Parts | | | | | |
| Ratio of D in | % | 45 | 45 | 45 | 45 | 45 |
| reinforced | | | | | | |
| thermoplastic resin | | | | | | |
| composition | | | | | | |

| | | | | | | |
|---|---|---|---|---|---|---|
| Charpy impact strength | kJ/m² | 18 | 13 | 11 | 12 | 11 |
| Flexural strength | MPa | 245 | 208 | 239 | 240 | 238 |
| Flexural modulus | MPa | 13400 | 12600 | 12700 | 12800 | 12700 |
| Flame retardancy | — | B | D | A | A | A |
| Heat resistance | ° C. | 94 | 95 | 95 | 95 | 95 |
| Moldability | — | B | A | A | A | A |

From the comparison between Example 3 and Comparative Example 15, it is clear that the reinforced thermoplastic resin composition of the present invention is superior to the reinforced thermoplastic resin composition containing no phosphoric acid ester-based flame retardant (F1) and sulfonic acid metal salt (G) in view of flame retardancy when being formed into a molded article.

From the comparison between Example 3 and Comparative Example 13, it is clear that the reinforced thermoplastic resin composition of the present invention is superior to the reinforced thermoplastic resin composition containing no sulfonic acid metal salt (G) in view of flame retardancy and heat resistance when being formed into a molded article.

From the comparison between Example 3 and Comparative Example 14, it is clear that the reinforced thermoplastic resin composition of the present invention is superior to the reinforced thermoplastic resin composition containing no phosphoric acid ester-based flame retardant (F1) in view of flame retardancy when being formed into a molded article.

From the comparison between Example 3 and Comparative Example 19, it is clear that the reinforced thermoplastic resin composition of the present invention is superior to the reinforced thermoplastic resin composition that contains the same amount of phosphoric acid ester-based flame retardant (F) but does not contain the phosphoric acid ester-based flame retardant (F1) in view of flame retardancy and heat resistance when being formed into a molded article.

[Industrial Applicability]

The reinforced thermoplastic resin composition of the present invention is particularly useful as a material for the housing and internal parts of mobile devices (laptop-type and tablet-type personal computers, mobile phones including smartphones, digital cameras, digital video cameras and the like), and is therefore extremely important industrially.

We claim:

1. A reinforced thermoplastic resin composition comprising:
a polycarbonate resin (A);
a graft copolymer (B) obtained by polymerizing a monomer mixture including an aromatic alkenyl compound monomer (a) and a vinyl cyanide compound monomer (b) in the presence of a rubbery polymer (B1);
a glass fiber (D) which is surface-treated with a water-soluble polyurethane and which has a ratio between a major axis and a minor axis ((major axis)/(minor axis)) on a fiber cross section of at least 2 and not more than 6;
a glycidyl ether unit-containing polymer (E) which includes a glycidyl ether unit and has a mass average molecular weight of 3,800 to 60,000 (with a proviso that said graft copolymer (B) is excluded);
a phosphoric acid ester-based flame retardant (F1) having a mass average molecular weight of 300 to 430;
a phosphoric acid ester-based flame retardant (F2) having a mass average molecular weight of 550 to 692; and
a sulfonic acid metal salt (G),
wherein a content ratio of said polycarbonate resin (A) is from 93 to 99% by mass with respect to a total mass of 100% by mass of said polycarbonate resin (A) and said graft copolymer (B),
a content ratio of said graft copolymer (B) is from 1 to 7% by mass with respect to a total mass of 100% by mass of said polycarbonate resin (A) and said graft copolymer (B),
a content ratio of said glass fiber (D) is from 30 to 50% by mass with respect to a total mass of 100% by mass of said polycarbonate resin (A), said graft copolymer (B), said glass fiber (D), said glycidyl ether unit-containing polymer (E), said phosphoric acid ester-based flame retardant (F1), said phosphoric acid ester-based flame retardant (F2) and said sulfonic acid metal salt (G),
a content of said glycidyl ether unit-containing polymer (E) is from 1 to 10 parts by mass with respect to a total of 100 parts by mass of said polycarbonate resin (A) and said graft copolymer (B),
a content of said phosphoric acid ester-based flame retardant (F1) is from 0.5 to 5 parts by mass with respect to a total of 100 parts by mass of said polycarbonate resin (A) and said graft copolymer (B),
a content of said phosphoric acid ester-based flame retardant (F2) is from 19.5 to 25 parts by mass with respect to a total of 100 parts by mass of said polycarbonate resin (A) and said graft copolymer (B),
a total of the content of said phosphoric acid ester-based flame retardant (F1) and the content of said phosphoric acid ester-based flame retardant (F2) is from 21 to 29 parts by mass with respect to a total of 100 parts by mass of said polycarbonate resin (A) and said graft copolymer (B), and
a content of said sulfonic acid metal salt (G) is from 0.03 to 0.5 parts by mass with respect to a total of 100 parts by mass of said polycarbonate resin (A) and said graft copolymer (B).

2. A molded article which is formed through molding and processing of the reinforced thermoplastic resin composition according to claim 1.
